(19) United States
(12) Patent Application Publication
(10) Pub. No.: US 2002/0108376 A1
(43) Pub. Date: Aug. 15, 2002

(54) Thermal management system for turbomachinery

(76) Inventor: Eloy C. Stevens, Indianapolis, IN (US)

Correspondence Address: Woodard, Emhardt, Naughton, Moriarty and McNett, Bank One Center/Tower, Suite 3700, 111 Monument Circle, Indianapolis, IN, 46204-5137, US

(21) Appl. No.: 10/027,436

(22) Filed: Dec. 21, 2001

Related U.S. Application Data
(60) Provisional application No. 60/268,769, filed on Feb. 14, 2001.

(51) Int. Cl. F02C 1/00

(52) U.S. Cl. 60/772

(57) ABSTRACT

A gas turbine engine thermal management system. In one form an atomized cooling agent is delivered into a non primary gas flow path. A portion of compressor bleed air is passed into the non primary gas flow path. The compressor bleed air and atomized cooling agent function to cool components within the engine.

The present application claims the benefit of a U.S. Provisional Patent Application serial No. 60/268,769 filed Feb. 14, 2001, and entitled THERMAL MANAGEMENT SYSTEM FOR TURBOMACHINERY. The Provisional Patent Application is incorporated herein by reference.

### BACKGROUND OF THE INVENTION

The present invention relates generally to a gas turbine engine thermal management system. More particularly, in one embodiment, the present invention delivers an atomized cooling media within a gas turbine engine internal cavity that is not a primary gas flow path. The cooling media is adapted to cool components within the engine. Although, the present invention was developed for use in aircraft gas turbine engines, certain applications may be outside of this field.

Aircraft engines can be classified broadly into three general categories or types: turbo engines, e.g., turbo-fan, turbo-jet and turbo-prop; ram jet (or scramjet for even higher Mach numbers); and pulse jet or pulse detonation. The present invention is particularly applicable to turbo engines and for the sake of brevity; the invention will be described herein primarily as applied to turbo engines. The continued demand for aircraft that can fly faster, farther and higher continues to push the capability of conventional turbomachinery.

In response to the increased demands many engine designers have injected fluids, such as water and alcohol, into the compressors and/or combustors of the primary flow path of the gas turbine engine. This fluid injection technique has been principally to increase engine power or thrust during the aircraft takeoff. However, as operational requirements for higher compressor pressure ratios and/or higher flight Mach numbers continue, thermal management throughout the engine becomes an issue of great importance. To date, the hostile thermal environment introduced into an engine at high speed has limited practical flight Mach numbers to three (3) or less with engine inlet temperatures exceeding 600° F. At Mach 4 the inlet temperature increases to around 1200° F., and at Mach 5 the inlet temperature increases to around 1900° F. These elevated temperatures place the internal engine components in increasing thermal distress.

The present invention provides a novel and non-obvious thermal management system that addresses the increased thermal demands placed on the engine's internal components.

### SUMMARY OF THE INVENTION

One form of the present invention contemplates a gas turbine engine including a thermal management system. The thermal management system includes a coolant delivery means to deliver a coolant within an internal non-primary-flow-path cavity of the engine.

Another form of the present invention contemplates a thermal management process for a gas turbine engine, comprising: increasing the pressure of a working fluid within a compressor of the gas turbine engine; discharging a portion of the working fluid into a non-primary-flow-path cavity within the gas turbine engine; delivering a coolant into the non-primary-flow-path cavity; and mixing the coolant and the portion of the working fluid within the non-primary-flow path cavity.

Another form of the present invention contemplates a method, comprising: providing a gas turbine engine including a compressor, a combustor and a turbine, the gas turbine engine having a primary flow path and an internal cavity that is substantially separate from the primary flow path, a portion of the primary flow path is defined within the compressor; passing a working fluid into the portion of the primary flow path within the compressor; delivering a portion of the working fluid from the portion of the primary flow path into the internal cavity after the passing; and spraying a coolant into the internal cavity.

Yet another form of the present invention contemplates an apparatus, comprising: a gas turbine engine having a compressor, a combustor and a turbine operatively coupled together, the gas turbine engine includes a mechanical housing with a primary working fluid flow path adapted for the passage of a first portion of a working fluid therethrough and an internal cavity that is not part of the primary working fluid flow path; a discharge in fluid communication with the compressor and adapted for the passage of a second portion of the working fluid to the internal cavity; and a fluid source in fluid communication with the internal cavity and adapted to deliver a coolant into the internal cavity.

Yet another form of the present invention contemplates an apparatus, comprising: a gas turbine engine having a compressor section, a combustor section and a turbine section operatively coupled together, the gas turbine engine includes a housing with a primary working fluid flow passageway therein adapted for the passage of a first portion of a working fluid therethrough and an internal cavity that is not part of the primary working fluid flow passageway; a discharge in fluid communication with the primary working fluid flow passageway and adapted for the passage of a second portion of the working fluid to the internal cavity; and coolant delivery means for delivering a coolant into the internal cavity.

One object of the present invention is to provide a unique thermal management system for a gas turbine engine.

Related objects and advantages of the present invention will be apparent from the following description.

### BRIEF DESCRIPTION OF THE DRAWINGS

FIG. 1 is an illustrative view of an aircraft powered by an aircraft flight propulsion engine that includes a thermal management system of the present invention.

FIG. 2 is a schematic illustration of a portion of a gas turbine engine comprising one embodiment of the thermal management system of the present invention.

FIG. 3 is an enlarged view of a portion of the FIG. 2 gas turbine engine.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

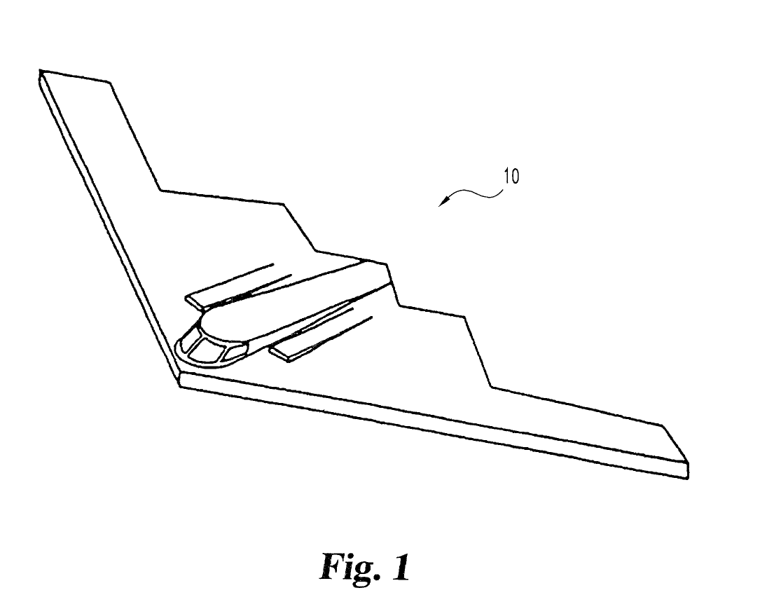

With reference to FIG. 1, there is illustrated an aircraft 10 that is powered by an aircraft flight propulsion engine which includes a thermal management system of the present invention. The term aircraft is generic and includes, but is not limited to, helicopters, airplanes, missiles, unmanned space devices, transatmospheric vehicles and other substantially similar devices. The FIG. 1 drawing is merely illustrative and is not intended to limit the meaning of the term aircraft in any manner.

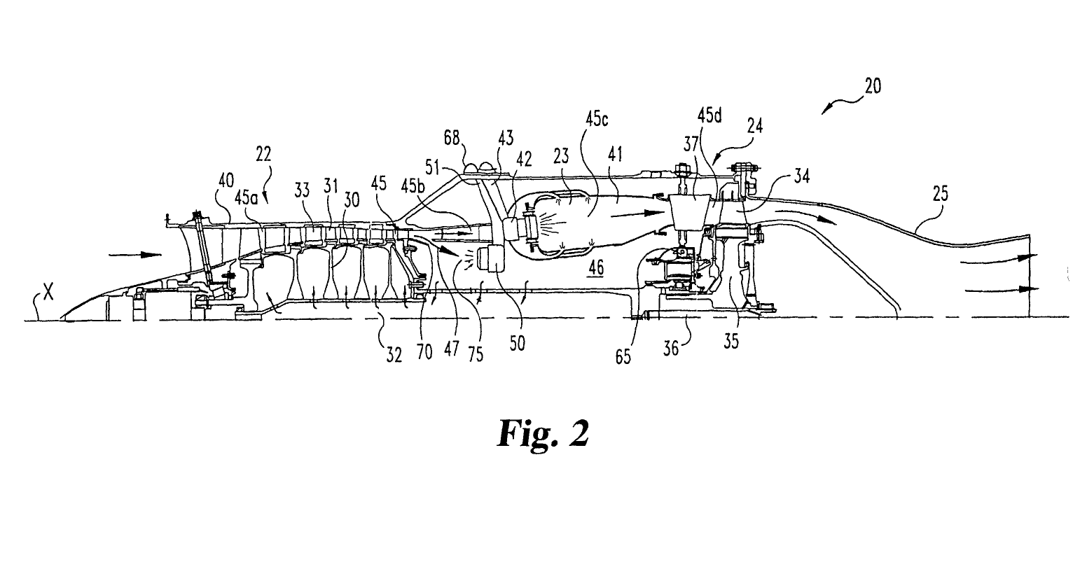

Referring to FIG. 2, there is illustrated a schematic representation of a gas turbine engine 20 which includes a compressor section 22, a combustor section 23, and a turbine section 24 that are integrated together to produce an aircraft flight propulsion engine. More specifically, FIG. 2 provides an illustrative meridian sectional view of a turbojet engine. The present invention will be described with reference to a turbojet engine, however there is no intention to limit the present invention to a turbojet engine, and other types of gas turbine engines are contemplated herein. The present invention is applicable, but not limited, to gas turbine engines utilized in aircraft capable of subsonic and/or supersonic speeds. In a preferred form, the engine is capable of speeds at or below Mach 6. In a more preferred form, the aircraft is capable of maximum speeds in the range of about Mach 4 to about Mach 5. However, the present invention is not limited to use in aircrafts having the above speed requirements, unless specifically provided to the contrary. One alternate form of a gas turbine engine includes a compressor, a combustor, a fan section, and a turbine that have been integrated together to produce an aircraft flight propulsion engine, which is generally referred to as a turbo-fan.

The turbine section 24 receives combustion gases from the combustor section 23 and the power developed by the turbine section 24 is utilized to drive the compressor and various engine auxiliaries. The remaining energy in the gases exhausted from the turbine section 24 is available to propel the aircraft. Thus, forward thrust for the turbojet engine is provided by the high velocity flow of gases that emerge from the turbine section 24 and which are exhausted through the exhaust nozzle 25. It is important to realize that there are multitudes of ways in which the gas turbine engine components can be linked together. Additional compressors and turbines could be added with intercoolers connecting between the compressors and reheat combustion chambers could be added between the turbines. Further, a gas turbine engine is equally suited to be used for an industrial application. Historically, there has been widespread application of industrial gas turbine engines, such as pumping sets for gas and oil transmission lines, electricity generation, and naval propulsion. Further, gas turbine engines are applicable for providing motive force for land based vehicles.

In one form the compressor section 22 includes at least one compressor disk 30 having a plurality of compressor blades 31 coupled thereto. While the particular embodiment of compressor section 22 includes five disks with a plurality of compressor blades it is understood that other quantities of disks are contemplated herein. Each of the compressor disks is coupled to and rotatable with a shaft disposed within the engine 20. The shaft 32 is mounted on and rotatably supported by bearings (not illustrated). In one embodiment disk 30 is affixed to a shaft 32 that is rotatable within the gas turbine engine 20. A plurality of compressor vanes 33 are positioned within the compressor section 22 between the compressor disks 30 and blades 31 to direct the fluid flow relative to the compressor blades 31.

Turbine section 24 includes a plurality of turbine blades 34 that are coupled to a disk 35. While the particular embodiment of turbine section 24 includes one disk 35 with a plurality of blades 34 it is understood that other quantities of disks are contemplated herein. Disk 35 is affixed to a shaft 36, which is rotatable within the gas turbine engine 20. The shaft 36 is supported by and rotatable on bearing 65. A plurality of vanes 37 are positioned within the turbine section 24 and direct the hot exhaust gases exiting the combustor section 23 relative to the blades 34. Further details related to the principles and components of a conventional gas turbine engine will not be described herein as they are believed known to one of ordinary skill in the art.

The compressor disk 30 and blades 31 can be formed of metallic or non-metallic material. In one embodiment the compressor disk 30 and the plurality of blades 31 are formed of non-metallic material. The non-metallic compressor disk 30 and the plurality of blades 31 are not actively cooled in this embodiment. In another embodiment the blades 31 are not actively cooled and are formed of a non-metallic material, while the disk is formed of a metallic material that is actively cooled. The present invention contemplates that the disks and blades can be formed of metallic or non-metallic material and can be actively cooled or not actively cooled as required by design parameters. Further, the disks and blades can be integrally formed as in a blisk, integrally cast, or assembled from subcomponents into an assembly. Further, the metallic or intermetallic materials contemplated herein include alloys and complex super alloy materials that are typically used or contemplated for use in gas turbine engine components. The present application contemplates cast, forged, powder metal and other methods generally known to one of skill in the art for forming gas turbine engine components. The crystallography of the metallic components can be selected from equiaxed, directionally solidified and/or single crystal to meet the design parameters. The intermetallic materials include, but are not limited to titanium-aluminide, nickel-aluminide and niobium-silicide. The non-metallic material includes, but is not limited to carbon-carbon, ceramics and/or ceramic matrix composites. One preferred ceramic material is silicon nitride. Further, in one embodiment the components are coated with a thermal or radiation barrier coating. However, it is understood herein that all of the components, some of the components or none of the components may be coated with a thermal or radiation barrier coating.

The turbine disk 35 and plurality of blades 34 can be formed of metallic or non-metallic material. However, in the preferred embodiment the turbine disk and plurality of blades 34 are formed of super alloy materials. The plurality of vanes 37 is formed of a material that is capable of withstanding the environment at the exit of the combustor that includes the high temperature exhaust exiting the combustor section 23. The plurality of vanes can be actively cooled or non-actively cooled in order to meet the design parameters of the engine. The crystallography of the metallic components can be selected from equiaxed, directionally solidified and/or single crystal to meet the design parameters. The non-metallic materials include, but are not limited to, ceramics and/or ceramic matrix composites. One preferred ceramic material is silicon nitride. Further, in one embodiment the components are coated with a thermal or radiation barrier coating. However, it is understood herein that all of the components, some of the components or none of the components may be coated with a thermal or radiation barrier coating.

An example of material selections for one form of the present invention will be set forth below. This form is only one example and no limitation on the selection of materials for the respective components of the engine is contemplated herein unless specifically provided to the contrary. The compressor case 40 is formed of a ceramic matrix composite and the combustor 41 is formed of a high temperature super alloy or intermetallic material. The compressor blades 31 and vanes 33 are formed of a ceramic material, and more preferably the ceramic material is silicon nitride. The disk 30, disk 35, blades 34 and vanes 37 are formed of super alloy materials.

The combustor section 33 includes a plurality of spaced fueling nozzles 42 located in fluid communication with the combustor to deliver fuel for combustion therein. In a preferred form of the present invention the fueling nozzles 42 are circumferentially spaced. A manifold 43 delivers fuel to each of the fueling nozzles 42. High-pressure working fluid from the compressor section 22 is delivered from the compressor section 22 into the combustor section 23. A portion of the high-pressure working fluid is bled off from the primary flow path 45 and is delivered into the internal cavity 46. In one form of the present invention the working fluid to utilize as bleed air is obtained at the compressor discharge, however in alternate embodiments the bleed air is obtained at intermediate locations within the compressor. The primary flow path can generally be defined as a passageway through the compressor section, combustor section and/or turbine section. In one form of the present invention the primary flow path has a substantially annular configuration, however other configurations are contemplated herein.

In the primary flow path there is generally work performed on the working fluid and/or energy added and/or extracted from the working fluid. In one form the primary flow path includes: passageway 45a where the compressor blades perform work on the working fluid; passageway 45b where the pressurized working fluid is delivered to the combustor; internal volume 45c of the combustor; and passageway 45d where the turbine blades extract energy from the combustion gas. The term working fluid as utilized herein is intended to have a broad meaning as understood by those of ordinary skill in the art. In a preferred embodiment the working fluid comprises air. Arrow 47 illustrates the passage of the compressor bleed air form the primary flow path 45 into the internal cavity 46. It should be understood that the internal cavity 46 is not considered a part of the primary gas flow path within the engine.

In one form of the present invention there is a coolant source 50 associated with each fuel nozzle 42. However, other quantities of coolant sources are contemplated herein. Coolant source 50 is adapted to deliver a coolant 75 into the internal cavity 46. In one form of the present invention a nozzle defines the coolant source 50. One embodiment of the coolant source delivers the coolant in a spray, and more preferably in a fine spray. In a preferred form of the present invention the nozzle atomizes the coolant to be delivered into the internal cavity 46. In one form of the present invention the coolant source 50 is positioned within the internal cavity 46. However, in another form of the present invention the coolant source 50 is located external to the internal cavity 46 and a fluid delivery passageway is adapted to deliver the coolant into the internal cavity 46 from the coolant source 50. In a more preferred form of the present invention an effervescent atomizer defines the coolant source. A commonly owned U.S. patent application Ser. No. 09/351,872, filed on Jul. 13, 1999 provides detail regarding an effervescent atomizer fluid delivery system and is incorporated herein by reference. In one embodiment, a coolant delivery passageway 51 is coupled to a manifold 68 that is in fluid communication with a coolant reservoir containing a quantity of coolant. The coolant reservoir is carried on board the aircraft.

The coolant is selected to be a relatively inert material within the internal cavity such as, but not limited to water. However, other materials are contemplated herein for the coolant. In one form the coolant source 50 discharges the coolant into the internal cavity 46 to bathe a portion and/or the substantial entire internal engine cavity 46 and/or components therein with the coolant and the compressor discharge air. In one form the coolant and compressor discharge air define an internal cavity cooling media, and in a more preferred form the coolant is atomized and this coolant and the compressor discharge air define the internal cavity cooling media. The internal cavity cooling media is adapted to cool the non primary gas path components, such as, but not limited to: cases, seals, diffuser, combuster liner, bearings, support structures, tailcone and compressor and turbine disks. In one form of the present invention the internal cavity cooling media will also function to help cool the turbine vanes and blades. In one form of the present invention the coolant is discharged from the coolant source in a direction substantially counter to the direction of the compressor discharge air entering the internal cavity. However, in other forms of the present invention the coolant is discharged in directions that are not counter to the discharge direction of the compressor discharge air. The quantity of coolant delivered from the coolant source 50 will be selected to mix with the compressor discharge air and obtain the desired temperature for the internal cavity cooling media. More specifically, the engine designer can establish the internal cavity cooling media temperature by balancing the mission requirements (i.e., range and/or gross weights) and the temperature constraints of the engine components. The required quantity of coolant delivered from the coolant source is then determined by the desired internal cavity cooling media temperature. For example, a greater quantity of coolant delivered to the internal cavity will allow a decrease in the quantity of compressor discharge air required in the internal cavity.

In another form of the present invention the internal cavity cooling media and/or coolant and/or compressor discharge air is selectively cooled by a heat exchanger disposed in fluid communication with the internal cavity. In a preferred form the heat exchanger is a fuel-to-air heat exchanger. One form of a fuel-to-air heat exchanger is disclosed in commonly owned U.S. patent application Ser. No. 09/523,815, filed on Mar. 13, 2000, which is incorporated herein by reference. However, it is understood that the present invention is not limited to the specific heat exchanger disclosed in the above pending U.S. patent application and other heat exchangers are contemplated herein.

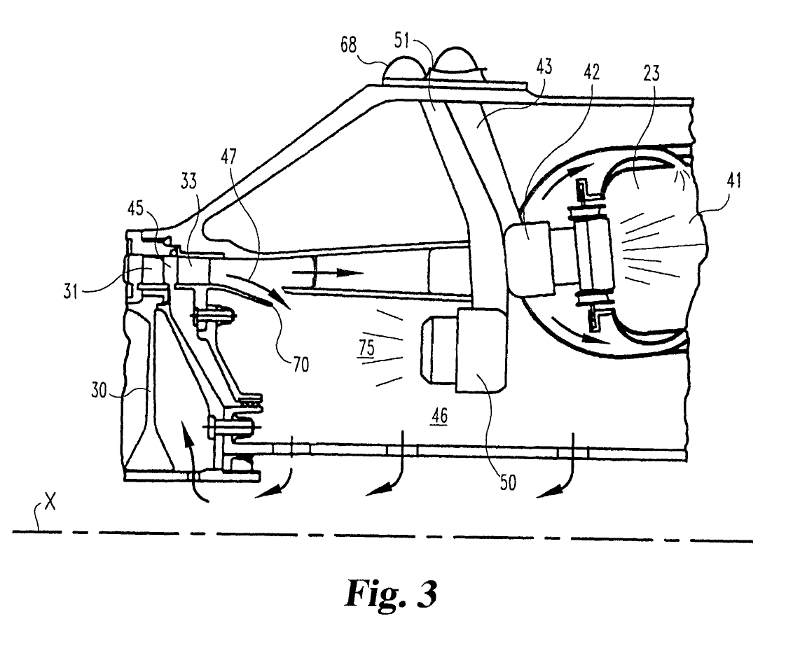

With reference to FIG. 3, a functional description of one form of the thermal management system of the present invention will be described. The working fluid exiting the compressor has a portion discharged through discharge 70 into the internal cavity 46 and another portion directed to the combustor section 23. Coolant 75 from the coolant source 50 is delivered into the internal cavity 46, and in one form the coolant is injected. In one form the coolant delivered by the coolant source 50 and compressor discharge air mix to form an internal cavity cooling media. The compressor discharge air entering the internal cavity is indicated schematically at arrow 47. This internal cavity cooling media is disposed in heat transfer relationship with the internal cavity and the components in the internal cavity and functions to provide cooling thereto. In one embodiment of the present invention the atomized coolant is vaporized and undergoes a conversion to steam during the cooling of the internal components.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In reading the claims, it is intended that when words such as “a,” “an,” “at least one,” or “at least a portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A thermal management process for a gas turbine engine, comprising:
increasing the pressure of a working fluid within a compressor of the gas turbine engine;
discharging a portion of the working fluid into a non-primary-flow-path cavity within the gas turbine engine;
delivering a coolant into the non-primary-flow-path cavity; and
mixing the coolant and the portion of the working fluid within the non-primary-flow path cavity.

2. The process of claim 1, wherein in said discharger the portion of the working fluid is obtained from the compressor.

3. The process of claim 1, wherein the coolant and the portion of the working fluid define a cavity cooling media, and further comprising distributing the cavity cooling media within the non-primary-flow-path cavity.

4. The process of claim 3, wherein said distributing places the cavity cooling media in a heat transfer relationship with components within the non-primary-flow-path cavity.

5. The process of claim 1, wherein the working fluid is air and the coolant includes water.

6. The process of claim 1, wherein said delivering includes spraying the coolant into the non-primary-flow-path cavity.

7. The process of claim 6, wherein said spraying occurs at a plurality of spaced locations within the non-primary-flow-path cavity.

8. The process of claim 1, wherein said delivering includes atomizing the coolant.

9. The process of claim 1, wherein the coolant and the portion of the working fluid define an internal cooling media, and further comprising cooling components within the non-primary-flow-path cavity with the internal cooling media.

10. A method, comprising:
(a) providing a gas turbine engine including a compressor, a combustor and a turbine, the gas turbine engine having a primary flow path and an internal volume that is substantially separate from the primary flow path, a portion of the primary flow path is defined within the compressor;
(b) passing a working fluid into the portion of the primary flow path within the compressor;
(c) delivering a portion of the working fluid from the portion of the primary flow path into the internal volume after said passing; and
(d) spraying a coolant into the internal volume.

11. The method of claim 10, wherein the internal volume defines an internal cavity.

12. The method of claim 10, wherein said spraying mixes the coolant and the portion of the working fluid within the internal volume.

13. The method of claim 10, wherein said spraying occurs within the internal volume.

14. The method of claim 10, wherein the working fluid is air and the coolant is an inert liquid.

15. The method of claim 10, further comprising vaporizing at least a portion of the coolant within the internal volume.

16. The method of claim 10, which further includes providing an aircraft, and wherein the gas turbine engine is coupled to the aircraft, and which further comprises repeating acts (b) through (d) as the aircraft moves at speeds within the range of about MACH 3 to about MACH 6.

17. The method of claim 10, which further includes providing an aircraft, and wherein the gas turbine engine is coupled to the aircraft, and which further comprises repeating acts (b) through (d) as the aircraft moves at speeds within the range of about MACH 4 to about MACH 5.

18. An apparatus, comprising:
a gas turbine engine including a compressor, a combustor and a turbine operatively coupled together, said gas turbine engine includes a mechanical housing with a primary working fluid flow path adapted for the passage of a first portion of a working fluid therethrough and an internal cavity that is not part of the primary working fluid flow path;
a discharge in fluid communication with said compressor and adapted for the passage of a second portion of the working fluid to said internal cavity; and
a fluid source in fluid communication with said internal cavity and adapted to deliver a coolant into said internal cavity.

19. The apparatus of claim 18, wherein said fluid source is adapted to atomize the coolant.

20. The apparatus of claim 18, wherein said fluid source is positioned within said internal cavity, and said fluid source is in fluid communication with a coolant reservoir adapted to contain the coolant.

21. The apparatus of claim 20, which further includes a coolant delivery passageway in fluid communication between said coolant reservoir and said fluid source.

22. The apparatus of claim 18, wherein said fluid source is external to said internal cavity, and which further includes a fluid delivery passageway in fluid communication with said fluid source and said internal cavity and adapted to deliver the coolant to said internal cavity.

23. The apparatus of claim 18, wherein said fluid source is defined by an effervescent atomizer.

24. The apparatus of claim 18, wherein said compressor includes a compressor discharge and wherein said discharge is proximate said compressor discharge.

25. The apparatus of claim 18, which further includes a plurality fueling sources adapted to deliver a fuel to said combustor, and which further includes a plurality of said fluid sources in fluid communication with said internal cavity and adapted to deliver the coolant into said internal cavity.

26. The apparatus of claim 18:
wherein said fluid source defines a plurality of spaced fluid sources in fluid communication with said internal cavity and adapted to deliver the coolant into said internal cavity;
wherein said plurality of fluid sources are positioned within said internal cavity; and
wherein said fluid source is adapted to atomize the coolant.

27. The apparatus of claims 26, wherein each of said plurality of fluid sources are adapted to deliver the coolant in a direction substantially counter to the direction of the second portion of the working fluid in said internal cavity.

28. The apparatus of claim 18, wherein said fluid source includes a nozzle.

29. An apparatus, comprising:
a gas turbine engine having a compressor section, a combustor section and a turbine section that are operatively coupled together, said gas turbine engine includes a housing with a pnmary working fluid flow passageway therein adapted for the passage of a first portion of a working fluid therethrough and an internal cavity that is substantially separate from the primary working fluid flow passageway;
a discharge in fluid communication with said primary working fluid flow passageway and adapted for the passage of a second portion of the working fluid to said internal cavity; and
coolant delivery means for delivering a coolant into said internal cavity.

30. The apparatus of claim 29, wherein a portion of said working fluid flow passageway is located within said compressor section, and wherein said discharge is in fluid communication with said portion.
